(19) United States
(12) Patent Application Publication
(10) Pub. No.: US 2019/0359084 A1
(43) Pub. Date: Nov. 28, 2019

(54) Interior Arrangements for Autonomous Vehicles

(71) Applicant: Uber Technologies, Inc., San Francisco, CA (US)

(72) Inventors: Johad Husseini Ellis, Pittsburgh, PA (US); Christopher Matthew D'Eramo, Bethel Park, PA (US)

(21) Appl. No.: 16/010,720

(22) Filed: Jun. 18, 2018

Related U.S. Application Data
(60) Provisional application No. 62/674,753, filed on May 22, 2018.

(51) Int. Cl. B60N 2/01; B60N 2/30; B60N 2/20; B60N 2/90; B60N 2/02

(52) U.S. Cl. CPC B60N 2/01; B60N 2/3081; G05D 1/0088; B60N 2/995; B60N 2/0224; B60N 2/20

(57) ABSTRACT

The present disclosure is directed to interior arrangements for autonomous vehicles. In particular, an autonomous vehicle can comprise an interior that includes a plurality of different portions. Each portion of the plurality of different portions can include one or more mechanical interfaces associated therewith. The interior can also include at least one modular interior unit configured to accommodate one or more passengers. The at least one modular unit can be coupled to one or more mechanical interfaces of at least one portion of the plurality of different portions of the interior.

### PRIORITY CLAIM

This application claims priority to U.S. Patent Application Ser. No. 62/674,753, filed May 22, 2018, and entitled “INTERIOR ARRANGEMENTS FOR AUTONOMOUS VEHICLES,” the disclosure of which is incorporated by reference herein in its entirety.

### FIELD

The present disclosure relates generally to autonomous vehicles. More particularly, the present disclosure relates to interior arrangements for autonomous vehicles.

### BACKGROUND

An autonomous vehicle is a vehicle that is capable of sensing its environment and navigating with minimal or no human input. In particular, an autonomous vehicle can observe its surrounding environment using a variety of sensors and identify an appropriate path through such surrounding environment.

### SUMMARY

Aspects and advantages of embodiments of the present disclosure will be set forth in part in the following description, or can be learned from the description, or can be learned through practice of the embodiments.

An example aspect of the present disclosure is directed to an autonomous vehicle comprising an interior. The interior can include a plurality of different portions. Each portion of the plurality of different portions can include one or more mechanical interfaces associated therewith. The interior can also include at least one modular interior unit configured to accommodate one or more passengers. The at least one modular unit can be coupled to one or more mechanical interfaces of at least one portion of the plurality of different portions of the interior.

Another example aspect of the present disclosure is directed to an autonomous-vehicle interior. The autonomous-vehicle interior can include first, second, third, and fourth sides. The first side can include one or more doors for one or more passengers to enter and exit the autonomous vehicle. Each of the second, third, and fourth sides can include one or more mechanical interfaces associated therewith. The autonomous-vehicle interior can also include one or more modular units coupled to the mechanical interface(s) of the second side and including a first reclining seat. The first reclining seat can be at least partially adjacent to the first side and can be configured to accommodate a first passenger of the passenger(s) such that the first passenger faces one of either a front of the autonomous vehicle or a rear of the autonomous vehicle. The autonomous-vehicle interior can further include one or more modular units coupled to the mechanical interface(s) of the third side and including a second reclining seat. The second reclining seat can be at least partially adjacent to the fourth side and can be configured to accommodate a second passenger of the passenger(s) such that the second passenger faces the second side. The autonomous-vehicle interior can further include one or more modular units coupled to the mechanical interface(s) of the fourth side and including one or more controls for adjusting the first reclining seat and/or the second reclining seat.

A further example aspect of the present disclosure is directed to an autonomous-vehicle interior. The autonomous-vehicle interior can include first, second, third, and fourth sides. The first side can include one or more doors for one or more passengers to enter and exit the autonomous vehicle. The second side can include a reclining seat and a bench seat. The third side can include a reclining seat and a bench seat. The reclining seat of the second side can be at least partially adjacent to the first side and can be configured to accommodate a first passenger of the passenger(s) such that the first passenger faces one of either a front of the autonomous vehicle or a rear of the autonomous vehicle. The bench seat of the second side can be at least partially adjacent to the fourth side of the autonomous vehicle and can be configured to accommodate a second passenger of the passenger(s) such that the second passenger faces the one of either the front of the autonomous vehicle or the rear of the autonomous vehicle. The fourth side can be opposite the first side. The reclining seat of the third side can be at least partially adjacent to the fourth side and can be configured to accommodate a third passenger of the passenger(s) such that the third passenger faces the second side. The bench seat of the third side can be at least partially adjacent to the first side and can be configured to accommodate a fourth passenger of the passenger(s) such that the fourth passenger faces the second side.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomous vehicle according to example embodiments of the present disclosure;

FIG. 2 depicts an example interior arrangement of an autonomous vehicle according to example embodiments of the present disclosure;

FIGS. 3A and 3B depict example portions of an interior arrangement of an autonomous vehicle according to example embodiments of the present disclosure;

FIG. 3C depicts an example mechanical interface of a portion of an interior arrangement of an autonomous vehicle according to example embodiments of the present disclosure;

FIGS. 4A-L depict example layouts of an interior arrangement of an autonomous vehicle according to example embodiments of the present disclosure;

FIGS. 5A-C depict example designs of aspects of an interior arrangement of an autonomous vehicle according to example embodiments of the present disclosure; and

FIG. 6 depicts an example design of an interior arrangement of an autonomous vehicle according to example embodiments of the present disclosure.

### DETAILED DESCRIPTION

Example aspects of the present disclosure are directed to an interior arrangement for an autonomous vehicle. In particular, an interior of an autonomous vehicle can include multiple different interior portions. Each of such interior portions can include one or more mechanical interfaces for coupling one or more modular interior units to the interior. For example, such modular interior unit(s) can be configured to accommodate one or more passengers of the autonomous vehicle (e.g., via one or more included seats, and/or the like). Additionally or alternatively, the unit(s) can include one or more controls for one or more functions of the autonomous vehicle (e.g., adjusting one or more positions of one or more seats of such modular interior units, stopping or starting the autonomous vehicle, adjusting interior lighting, adjusting interior audio, and/or the like). It will be appreciated that such an interior arrangement can enable an autonomous vehicle to be reconfigured to produce various interior layouts (e.g., via the inclusion of various different modular interior units, and/or the like), which may be particularly advantageous in the context of a fleet of autonomous vehicles serving varying demands, customers, markets, and/or the like.

An autonomous-vehicle interior can include multiple sides. In some embodiments, the interior can include one or more sides corresponding to either the front or the rear of the autonomous vehicle. For example, an autonomous vehicle can be configured to principally travel in either of two directions (e.g., the autonomous vehicle can be equally suited to travel in forward or reverse, the front and rear of the autonomous vehicle can be interchangeable, indistinguishable, and/or the like). In addition to the front/rear sides, the interior can include lateral sides connecting the front/rear sides. One or more of such lateral sides can include one or more doors for one or more passengers to enter and/or exit the autonomous vehicle. In some embodiments, one lateral side can include such door(s), while the other lateral side may not include such door(s). For example, an autonomous vehicle configured to principally travel in either of two directions can obviate the need to include such door(s) on both lateral sides (e.g., because the autonomous vehicle can be configured to travel in a direction such that the passenger(s) can enter and/or exit the autonomous vehicle on the side opposite traffic, and/or the like).

The interior portions including the mechanical interface(s) for coupling the modular interior unit(s) to the interior can border one or more of the interior sides. For example, one or more of the interior portions can border a front/rear side, one or more of the interior portions can border the other (e.g., opposite, and/or the like) front/rear side, one or more of the interior portions can border a lateral side, and/or one or more of the interior portions can border the other (e.g., opposite, and/or the like) lateral side. In some embodiments, one or more of the interior portions can border multiple sides. For example, an interior portion (e.g., located in a corner, and/or the like) can border a front/rear side and one or more lateral sides. Similarly, an interior portion can border a lateral side and one or more front/rear sides. In some embodiments, one or more of the interior portions can share a common geometry (e.g., a rectangle, and/or the like), which can be defined by at least two dimensions (e.g., length, width, and/or the like). In some of such embodiments, a first of the dimensions (e.g., length, and/or the like) can be an even multiple of (e.g., product of an integer with, and/or the like) a second of the dimensions (e.g., width, and/or the like).

In some embodiments, a modular interior unit comprising a bench seat configured to accommodate one or more passengers can be coupled to one or more mechanical interfaces of the interior portions. For example, such a unit (e.g., comprising a single straight bench seat, and/or the like) can be coupled to one or more mechanical interfaces of one or more interior portions bordering, at least in part, a front/rear side such that the passenger(s) accommodated by the unit face either the front or the rear of the autonomous vehicle (e.g., opposite the front/rear side having the mechanical interface(s) to which the unit is coupled, and/or the like). Similarly, such a unit (e.g., comprising a single straight bench seat, and/or the like) can be coupled to one or more mechanical interfaces of one or more interior portions bordering, at least in part, a lateral side such that the passenger(s) accommodated by the unit face the opposite lateral side (e.g., opposite the lateral side having the mechanical interface(s) to which the unit is coupled, and/or the like).

In some embodiments, multiple units comprising bench seats can be coupled to the mechanical interface(s) of the interior portions. For example, a first such unit (e.g., comprising a single straight bench seat, and/or the like) can be coupled to one or more mechanical interfaces of one or more interior portions bordering, at least in part, a front/rear side such that the passenger(s) accommodated by the unit face either the front or the rear of the autonomous vehicle (e.g., opposite the front/rear side having the mechanical interface(s) to which the unit is coupled, and/or the like), and a second such unit (e.g., comprising a single straight bench seat, and/or the like) can be coupled to one or more mechanical interfaces of one or more interior portions bordering, at least in part, the opposite front/rear side such that the passenger(s) accommodated by the unit face the other of the front or the rear of the autonomous vehicle (e.g., the passenger(s) accommodated by the first unit, and/or the like).

In some embodiments, a unit comprising a bench seat (e.g., an L-shaped seat, and/or the like) can be coupled to one or more mechanical interfaces of one or more interior portions bordering, at least in part, a front/rear side and one or more mechanical interfaces of one or more interior portions bordering, at least in part, a lateral side such that at least one of the passenger(s) accommodated by the unit faces either the front or the rear of the autonomous vehicle (e.g., opposite the front/rear side having the mechanical interface(s) to which the unit is coupled, and/or the like) and at least one of the passenger(s) accommodated by the unit faces a lateral side (e.g., opposite the lateral side having the mechanical interface(s) to which the unit is coupled, and/or the like).

In some embodiments, a unit comprising a bench seat (e.g., a U-shaped seat, and/or the like) can be coupled to one or more mechanical interfaces of one or more interior portions bordering, at least in part, a front/rear side, one or more mechanical interfaces of one or more interior portions bordering, at least in part, the opposite front/rear side, and one or more mechanical interfaces of one or more interior portions bordering, at least in part, a lateral side such that at least one of the passenger(s) accommodated by the unit faces either the front or the rear of the autonomous vehicle, at least one of the passenger(s) accommodated by the unit faces the other of the front or the rear of the autonomous vehicle, and at least one of the passenger(s) accommodated by the unit faces a lateral side (e.g., opposite the lateral side having the mechanical interface(s) to which the unit is coupled, and/or the like).

In some embodiments, a bench seat included in one or more of such units can comprise one or more stowable child seats for accommodating one or more passengers (e.g., children, and/or the like). In some of such embodiments, one or more portions of such stowable child seat(s) can fold into the bench seat (e.g., for storage, and/or the like).

In some embodiments, a modular interior unit configured to accommodate one or more passengers can include a reclining seat and can be coupled to one or more mechanical interfaces of the interior portions. For example, such a unit can be coupled to one or more mechanical interfaces of one or more interior portions bordering, at least in part, a front/rear side such that the passenger(s) accommodated by the unit face either the front or the rear of the autonomous vehicle (e.g., opposite the front/rear side having the mechanical interface(s) to which the unit is coupled, and/or the like). Similarly, in some embodiments, such a unit (e.g., including an additional reclining seat, and/or the like) can be coupled to one or more mechanical interfaces of one or more interior portions bordering, at least in part, the opposite front/rear side such that the passenger(s) accommodated by the unit face the other of the front or the rear of the autonomous vehicle (e.g., opposite the front/rear side having the mechanical interface(s) to which the unit is coupled, and/or the like). In some of such embodiments, the included reclining seats can be adjacent to opposite lateral sides (e.g., such that a passenger in a first of the seats faces in the direction of a passenger in a second of the seats but is not located directly across the interior from such passenger, and/or the like).

In some embodiments, one or more of the units including the reclining seat(s) can include one or more additional reclining seats, bench seats, and/or the like (e.g., such that passengers accommodated by the seats included in the unit face in the same direction, and/or the like). Additionally or alternatively, one or more units including one or more additional reclining seats, bench seats, and/or the like can be coupled to one or more mechanical interfaces of one or more interior portions adjacent to the interior portion(s) including the interface(s) to which the units including the reclining seat(s) are coupled (e.g., such that passengers accommodated by the adjacent units face in the same direction, and/or the like).

In some embodiments, the interior can include one or more modular floor panels. In some of such embodiments, the panel(s) can be secured to the interior, at least in part, by one or more of the modular interior units, for example, via one or more mechanical interfaces of the interior portions to which the unit(s) are coupled (e.g., one or more components of the interface(s) can pass through one or more openings in the panel(s), and/or the like). In some embodiments, the panel(s) can be configured to cover one or more mechanical interfaces of the portions of the interior (e.g., one or more interfaces not being utilized to couple a modular interior unit, and/or the like). For example, a panel can be secured to the interior, at least in part, by one or more units coupled to one or more interfaces of one or more interior portions bordering, at least in part, a particular side, and such panel can be configured to cover one or more interfaces of one or more interior portions bordering a different side. In some embodiments, one or more reclining seats included in one or more of the modular interior units can include a leg rest configured to extend into a cove defined, at least in part, by the panel(s).

In some embodiments, one or more of the portions of the interior can include one or more electronic interfaces for electronically interfacing the autonomous vehicle with one or more components of one or more modular interior units coupled to one or more mechanical interfaces of the interior portion(s). For example, one or more modular interior units (e.g., console units, seating units, and/or the like) can include one or more controls for one or more functions of the autonomous vehicle (e.g., adjusting one or more positions of one or more seats of such units, stopping or starting the autonomous vehicle, adjusting interior lighting, adjusting interior audio, and/or the like), and such unit(s) can include one or more electronic interfaces configured to electronically interface with one or more electronic interfaces of one or more of the portions of the interior including one or more mechanical interfaces to which such unit(s) are coupled.

In some embodiments, a unit coupled to mechanical interfaces of one or more portions of the interior can be electronically interfaced with the autonomous vehicle via an electronic interface of the interior portion(s), and a unit coupled to mechanical interfaces of one or more other portions of the interior can be electronically interfaced with the autonomous vehicle via an electronic interface of the other interior portion(s) and can include one or more controls configured to operate one or more functions of the other unit via the electronic interfaces. For example, one or more units can include one or more reclining seats having one or more electronically adjustable positions, and one or more units can include one or more controls configured to adjust the position(s). In some embodiments, the unit(s) including the control(s) can be distinct from the unit(s) including the reclining seat(s); can be coupled to one or more mechanical interfaces of one or more portions of the interior bordering, at least in part, a side (e.g., a lateral side, and/or the like) different from a side (e.g., a front/rear side, and/or the like) bordered, at least in part, by one or more portions of the interior including one or more mechanical interfaces to which the unit(s) including the reclining seat(s) are coupled; and/or the like. Additionally or alternatively, the unit(s) including the reclining seat(s) can include the control(s).

In some embodiments, one or more of the mechanical interfaces can include one or more components configured to interface with a device comprising specialized tooling for decoupling one or more units coupled to the interface(s). For example, such component(s) can make it difficult for an unauthorized individual (e.g., a passenger, and/or the like) to remove, reconfigure, and/or the like the unit(s).

The technology described herein can provide a number of technical effects and benefits. For example, the arrangement described herein can enable an autonomous vehicle to be reconfigured to produce various interior layouts (e.g., via the inclusion of various different modular interior units, floor panels, and/or the like), which may be particularly advantageous in the context of a fleet of autonomous vehicles serving varying demands, customers, markets, and/or the like. Moreover, the arrangement described herein can allow manufacture, operation, and/or the like of a fleet of autonomous vehicles of the same model that can be utilized, reconfigured, and/or the like for different purposes, thereby reducing costs, simplifying management, supporting more adept services, and/or the like.

With reference now to the Figures, example embodiments of the present disclosure will be discussed in further detail.

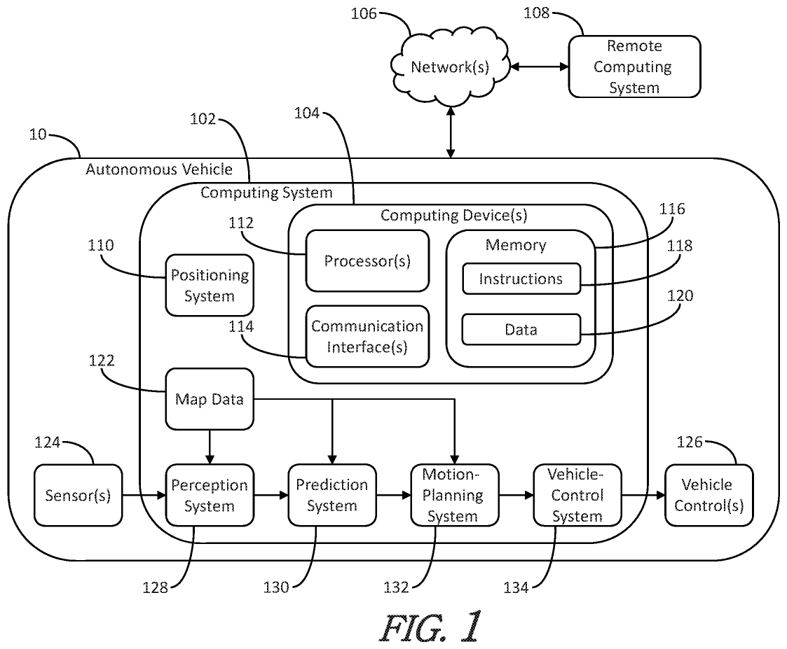

FIG. 1 depicts an example autonomous vehicle according to example embodiments of the present disclosure.

Referring to FIG. 1, autonomous vehicle 10 can be capable of sensing its environment, navigating its environment with minimal or no human input, and/or the like. Autonomous vehicle 10 can be a ground-based autonomous vehicle (e.g., car, truck, bus, and/or the like), an air-based autonomous vehicle (e.g., airplane, drone, helicopter, and/or the like), and/or other type of vehicle (e.g., watercraft, and/or the like). Autonomous vehicle 10 can include one or more sensors 124, computing system 102, and one or more vehicle controls 126. Computing system 102 can assist in controlling autonomous vehicle 10. For example, computing system 102 can receive data generated by sensor(s) 124, attempt to comprehend an environment surrounding autonomous vehicle 10 by performing various processing techniques on the data generated by sensor(s) 124, generate, determine, select, and/or the like a motion plan for navigating autonomous vehicle 10 through, within, and/or the like such surrounding environment, and/or the like. Computing system 102 can interface with vehicle control(s) 126 to operate autonomous vehicle 10 (e.g., in accordance with the motion plan, and/or the like).

Computing system 102 can include one or more computing devices 104. Computing device(s) 104 can include circuitry configured to perform one or more operations, functions, and/or the like described herein. For example, computing device(s) 104 can include one or more processor(s) 112, one or more communication interfaces 114, and memory 116 (e.g., one or more hardware components for storing executable instructions, data, and/or the like). Communication interface(s) 114 can enable computing device(s) 104 to communicate with one another, and/or can enable autonomous vehicle 10 (e.g., computing system 102, computing device(s) 104, and/or the like) to communicate with one or more computing systems, computing devices, and/or the like distinct from autonomous vehicle 10 (e.g., computing system 108, and/or the like). Memory 116 can include (e.g., store, and/or the like) instructions 118 and data 120. When executed by processor(s) 112, instructions 118 can cause autonomous vehicle 10 (e.g., computing system 102, computing device(s) 104, and/or the like) to perform one or more operations, functions, and/or the like described herein. Data 120 can include, represent, and/or the like information associated with such operations, functions, and/or the like, data generated by sensor(s) 124, and/or the like.

Computing system 102 can be physically located onboard autonomous vehicle 10, and computing system 108 can be distinct and/or remotely located from autonomous vehicle 10. One or more networks 106 (e.g., wired networks, wireless networks, and/or the like) can interface autonomous vehicle 10 (e.g., computing system 102, computing device(s) 104, and/or the like) with computing system 108, which can include one or more computing devices analogous to computing device(s) 104, one or more components (e.g., memory, processors, communication interfaces, and/or the like) analogous to those of computing device(s) 104, and/or the like. Irrespective of attribution described or implied herein, unless explicitly indicated otherwise, the operations, functions, and/or the like described herein can be performed by computing system(s) 102 and/or 108 (e.g., by computing system 102, by computing system 108, by a combination of computing systems 102 and 108, and/or the like).

Computing system 102 can include positioning system 110, which can include one or more devices, circuitry, and/or the like for analyzing, approximating, determining, and/or the like one or more geographic positions of autonomous vehicle 10. For example, positioning system 110 can analyze, approximate, determine, and/or the like such position(s) using one or more inertial sensors, triangulations and/or proximities to network components (e.g., cellular towers, WiFi access points, and/or the like), satellite positioning systems, network addresses, and/or the like. Computing system 102 can include perception system 128, prediction system 130, and motion-planning system 132, which can cooperate to perceive a dynamic environment surrounding autonomous vehicle 10, generate, determine, select, and/or the like a motion plan for autonomous vehicle 10, and/or the like.

Perception system 128 can receive data from sensor(s) 124, which can be coupled to or otherwise included within autonomous vehicle 10. Sensor(s) 124 can include, for example, one or more cameras (e.g., visible spectrum cameras, infrared cameras, and/or the like), light detection and ranging (LIDAR) systems, radio detection and ranging (RADAR) systems, and/or the like. Sensor(s) 124 can generate data including information that describes one or more locations, velocities, vectors, and/or the like of objects in the environment surrounding autonomous vehicle 10. For example, a LIDAR system can generate data indicating the relative location (e.g., in three-dimensional space relative to the LIDAR system, and/or the like) of a number of points corresponding to objects that have reflected a ranging laser of the LIDAR system. Such a LIDAR system can, for example, measure distances by measuring the interference between outgoing and incoming light waves, measuring the time of flight (TOF) it takes a short laser pulse to travel from a sensor to an object and back, calculating the distance based at least in part on the TOF with respect to the known speed of light, based at least in part on a phase-shift with known wavelength, and/or the like. As another example, a RADAR system can generate data indicating one or more relative locations (e.g., in three-dimensional space relative to the RADAR system, and/or the like) of a number of points corresponding to objects that have reflected a ranging radio wave of the RADAR system. For example, radio waves (e.g., pulsed, continuous, and/or the like) transmitted by such a RADAR system can reflect off an object and return to a receiver of the RADAR system, generating data from which information about the object's location, speed, and/or the like can be determined. As another example, for one or more cameras, various processing techniques, for example, range-imaging techniques (e.g., structure from motion, structured light, stereo triangulation, and/or the like) can be performed to identify one or more locations (e.g., in three-dimensional space relative to the camera(s), and/or the like) of a number of points corresponding to objects depicted in imagery captured by the camera(s).

Perception system 128 can retrieve, obtain, and/or the like map data 122, which can provide information about an environment surrounding autonomous vehicle 10. For example, map data 122 can provide information regarding: the identity and location of different travelways (e.g., roadways, and/or the like), road segments, buildings, other static items or objects (e.g., lampposts, crosswalks, curbing, and/or the like); the location and directions of traffic lanes (e.g., the location and/or direction of a parking lane, turning lane, bicycle lane, and/or the like); traffic-control data (e.g., the location and/or instructions of signage, traffic lights, other traffic-control devices, and/or the like); other map data providing information that can assist computing system 102 in comprehending, perceiving, and/or the like an environment surrounding autonomous vehicle 10, its relationship thereto, and/or the like.

Perception system 128 can (e.g., based at least in part on data received from sensor(s) 124, map data 122, and/or the like) identify one or more objects proximate to autonomous vehicle 10 and determine, for each of such object(s), state data describing a current state of the object, for example, an estimate of the object's: size/footprint (e.g., as represented by a bounding shape such as a polygon, polyhedron, and/or the like); class (e.g., vehicle, pedestrian, bicycle, and/or the like); current location (also referred to as position), speed (also referred to as velocity), acceleration, heading, orientation, yaw rate; and/or the like. In some embodiments, perception system 128 can determine such state data for each object over a number of iterations, for example, updating, as part of each iteration, the state data for each object. Accordingly, perception system 128 can detect, track, and/or the like such object(s) over time.

Prediction system 130 can receive state data from perception system 128 and can predict (e.g., based at least in part on such state data, and/or the like) one or more future locations for each object. For example, prediction system 130 can predict where each object will be located within the next five seconds, ten seconds, twenty seconds, and/or the like. As one example, an object can be predicted to adhere to its current trajectory according to its current speed. Additionally or alternatively, other prediction techniques, modeling, and/or the like can be used.

Motion-planning system 132 can generate, determine, select, and/or the like a motion plan for autonomous vehicle 10, for example, based at least in part on state data of object(s) provided by perception system 128, predicted future location(s) of object(s) provided by prediction system 130, and/or the like. For example, utilizing information about current location(s) of object(s), predicted future location(s) of object(s), and/or the like, motion-planning system 132 can generate, determine, select, and/or the like a motion plan for autonomous vehicle 10 that it determines (e.g., based at least in part on one or more operation parameters, and/or the like) best navigates autonomous vehicle 10 relative to the object(s). Motion-planning system 132 can provide the motion plan to vehicle-control system 134, which can directly and/or indirectly control autonomous vehicle 10 via vehicle control(s) 126 (e.g., one or more actuators, devices, and/or the like that control gas, power flow, steering, braking, and/or the like) in accordance with the motion plan.

Perception system 128, prediction system 130, motion-planning system 132, and/or vehicle-control system 134 can include logic utilized to provide functionality described herein. Perception system 128, prediction system 130, motion-planning system 132, and/or vehicle-control system 134 can be implemented in hardware (e.g., circuitry, and/or the like), firmware, software configured to control one or more processors, one or more combinations thereof, and/or the like. For example, instructions 118, when executed by processor(s) 112, can cause autonomous vehicle 10 (e.g., computing system 102, computing device(s) 104, and/or the like) to implement functionality of perception system 128, prediction system 130, motion-planning system 132, and/or vehicle-control system 134 described herein.

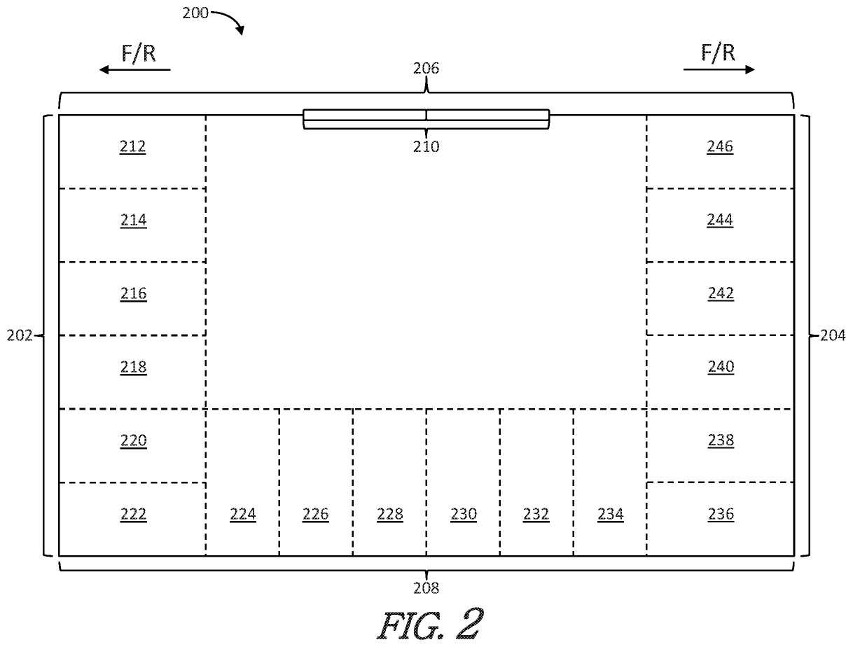

FIG. 2 depicts an example interior arrangement of an autonomous vehicle according to example embodiments of the present disclosure.

Referring to FIG. 2, autonomous vehicle 10 can include interior 200. Interior 200 can include multiple different sides. For example, interior 200 can include side 202 corresponding to either the front or the rear of autonomous vehicle 10, and interior 200 can include side 204 corresponding to the other of the front or the rear of autonomous vehicle 10. For example, in some embodiments, autonomous vehicle 10 can be configured to principally travel in either of two directions (e.g., autonomous vehicle 10 can be equally suited to travel in forward or reverse, the front and rear of autonomous vehicle 10 can be interchangeable, indistinguishable, and/or the like). Interior 200 can also include lateral sides 206 and 208 (e.g., connecting sides 202 and 204, and/or the like). Side 206 can include one or more doors 210 for one or more passengers to enter and/or exit autonomous vehicle 10.

In accordance with aspects of the disclosure, interior 200 can comprise multiple different interior portions. For example, interior 200 can include portions 212, 214, 216, 218, 220, 222, 224, 226, 228, 230, 232, 234, 236, 238, 240, 242, 244, and 246. One or more of the portions of interior 200 can border one or more of the sides of interior 200. For example, portions 212, 214, 216, 218, 220, and 222 can border side 202. Similarly, portions 222, 224, 226, 228, 230, 232, 234, and 236 can border side 208; portions 236, 238, 240, 242, 244, and 246 can border side 204; and portions 212 and 246 can border side 206. In some embodiments, one or more of the portions of interior 200 can border multiple different sides of interior 200. For example, portion 212 can border sides 202 and 206. Similarly, portion 222 can border sides 202 and 208; portion 236 can border sides 204 and 208; and portion 246 can border sides 204 and 206.

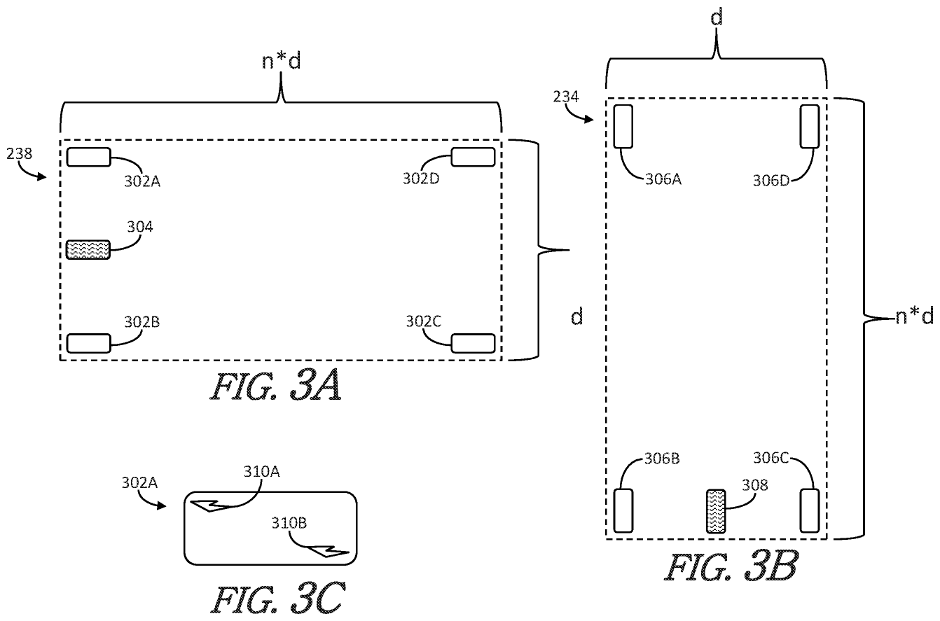

Each interior portion of interior 200 can include one or more mechanical interfaces for coupling one or more modular interior units to interior 200. For example, FIGS. 3A and 3B depict example portions of an interior arrangement of an autonomous vehicle according to example embodiments of the present disclosure. Referring to FIG. 3A, portion 238 can include mechanical interfaces 302A, 302B, 302C, and 302D. Similarly, referring to FIG. 3B, portion 234 can include mechanical interfaces 306A, 306B, 306C, and 306D. In some embodiments, one or more portions of interior 200 can include one or more electronic interfaces for electronically interfacing autonomous vehicle 10 with one or more components of one or more modular interior units coupled to the mechanical interface(s) of the interior portion(s). For example, referring to FIG. 3A, portion 238 can include electronic interface 304 for electronically interfacing autonomous vehicle 10 with one or more components of one or more modular interior units coupled to mechanical interface(s) 302A, 302B, 302C, and/or 302D. Similarly, referring to FIG. 3B, portion 234 can include electronic interface 308 for electronically interfacing autonomous vehicle 10 with one or more components of one or more modular interior units coupled to mechanical interface(s) 306A, 306B, 306C, and/or 306D.

In some embodiments, one or more portions of interior 200 can share a common geometry (e.g., a rectangle, and/or the like), which can be defined by at least two dimensions (e.g., length, width, and/or the like). For example, portions 234 and 238 can share a common geometry (e.g., a rectangle, and/or the like), which can be defined by at least two dimensions (e.g., d, n*d, and/or the like). In some of such embodiments, a first of the dimensions (e.g., n*d, and/or the like) can be an even multiple of (e.g., product of an integer (n) with, and/or the like) a second of the dimensions (e.g., d, and/or the like).

In some embodiments, one or more of the mechanical interfaces can include one or more components configured to interface with a device comprising specialized tooling for decoupling one or more units coupled to the interface(s). For example, FIG. 3C depicts an example mechanical interface of a portion of an interior arrangement of an autonomous vehicle according to example embodiments of the present disclosure. Referring to FIG. 3C, interface 302A can include components 310A and 310B, which can be configured to interface with a device comprising specialized tooling for decoupling one or more modular interior units coupled to interface 302A. For example, such component(s) can make it difficult for an unauthorized individual (e.g., a passenger, and/or the like) to remove, reconfigure, and/or the like one or more modular interior units coupled to such mechanical interface(s).

Interior 200 can include one or more modular interior units (e.g., coupled to one or more mechanical interfaces of the portions of interior 200, and/or the like). For example, such unit(s) can be configured to accommodate one or more passengers of autonomous vehicle 10 (e.g., via one or more included seats, and/or the like). Additionally or alternatively, the unit(s) can include one or more controls for one or more functions of autonomous vehicle 10 (e.g., adjusting one or more positions of one or more seats of such modular interior units, stopping or starting autonomous vehicle 10, adjusting interior lighting, adjusting interior audio, and/or the like).

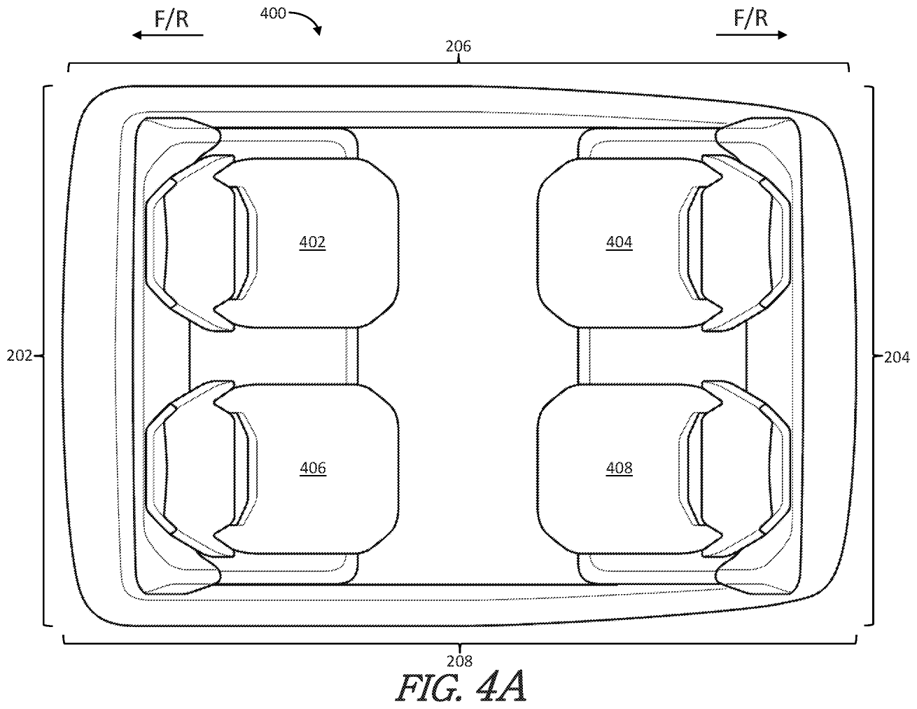

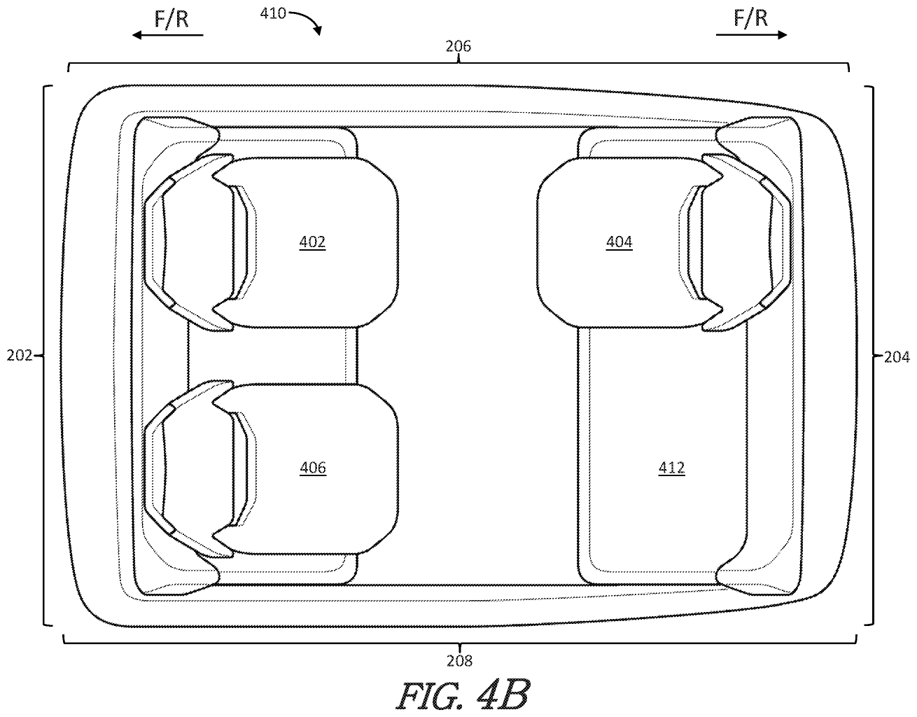

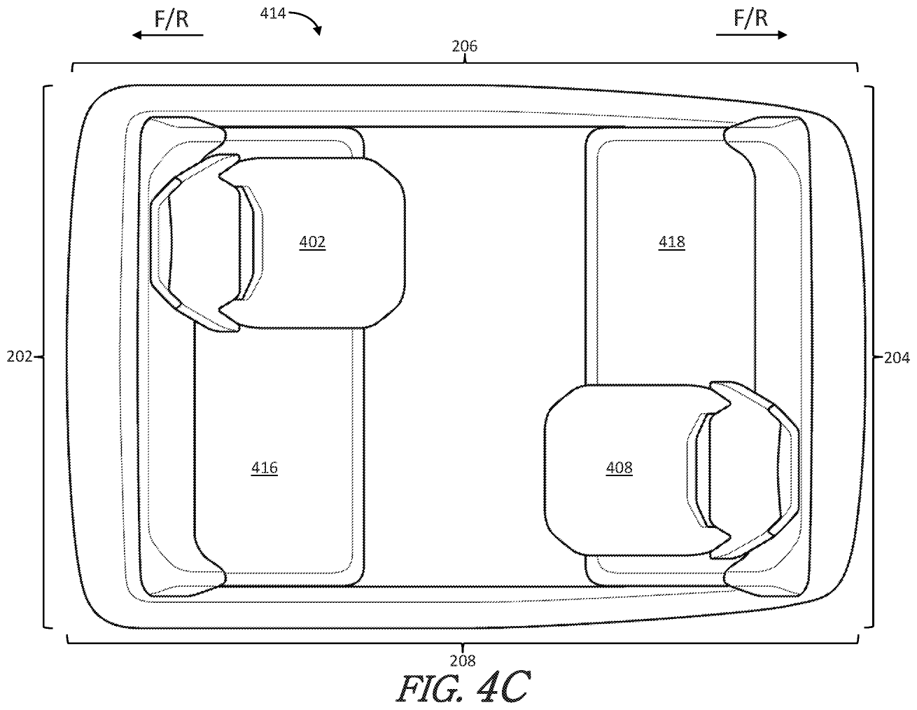

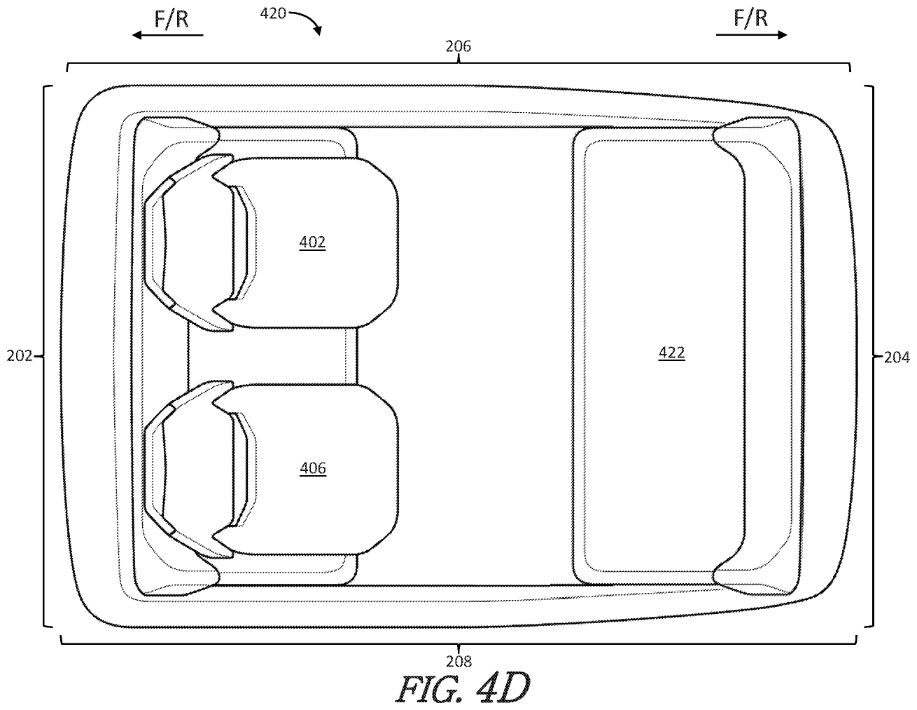

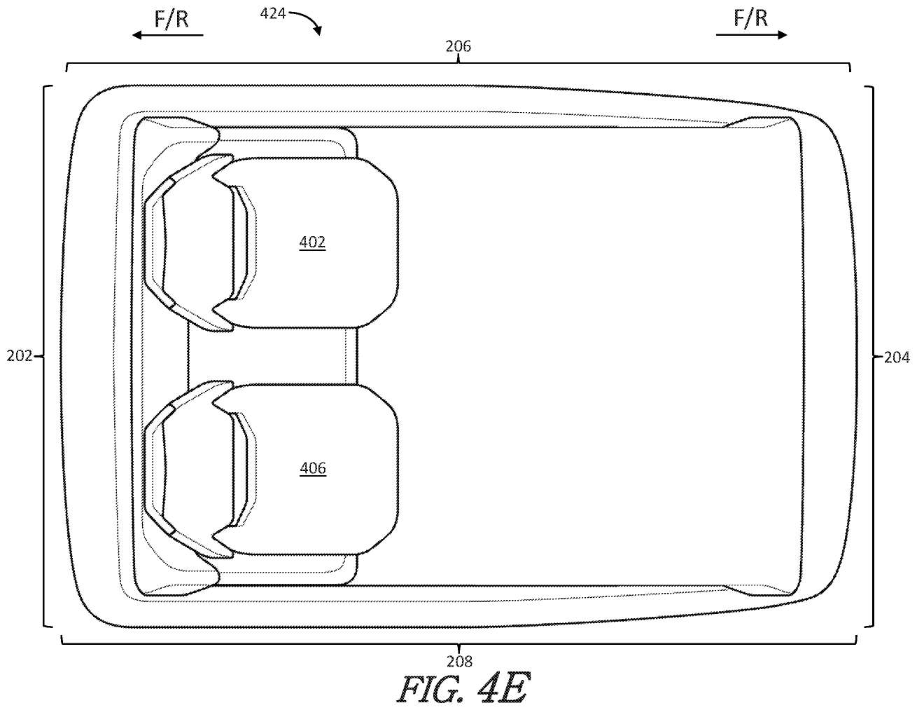

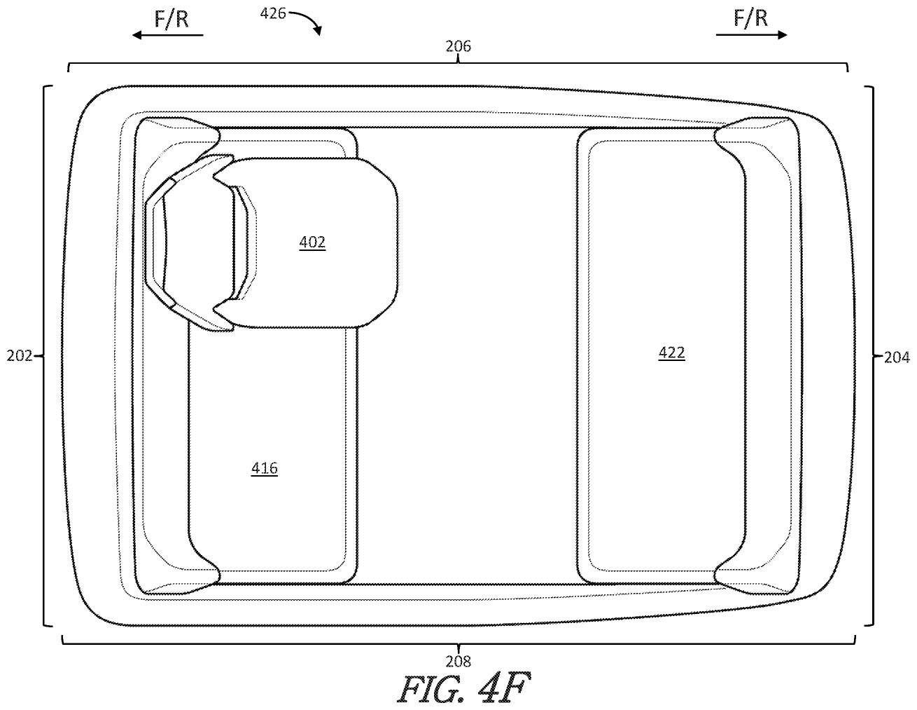

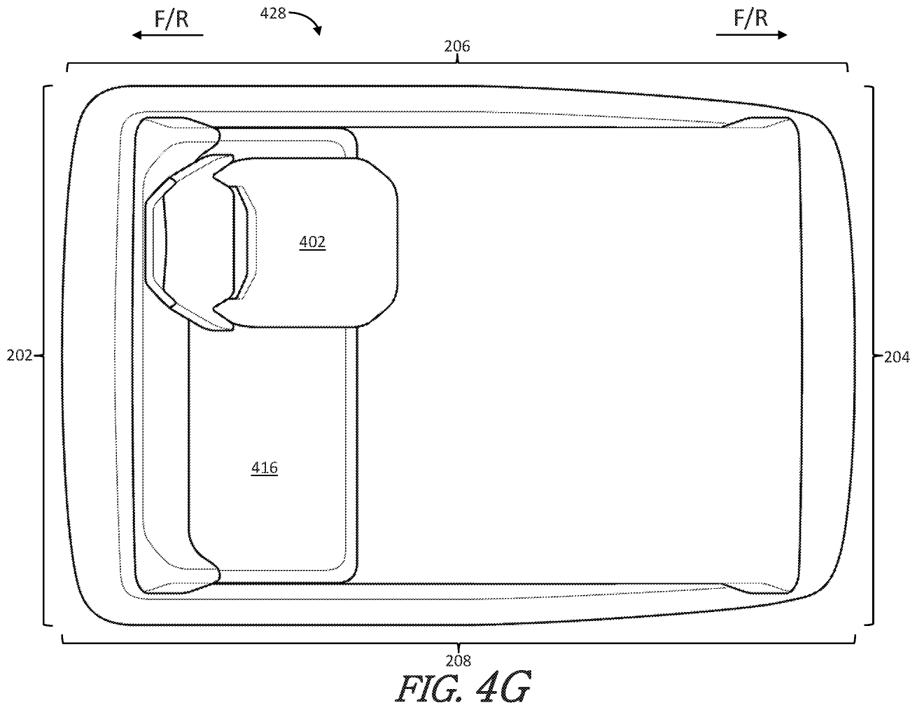

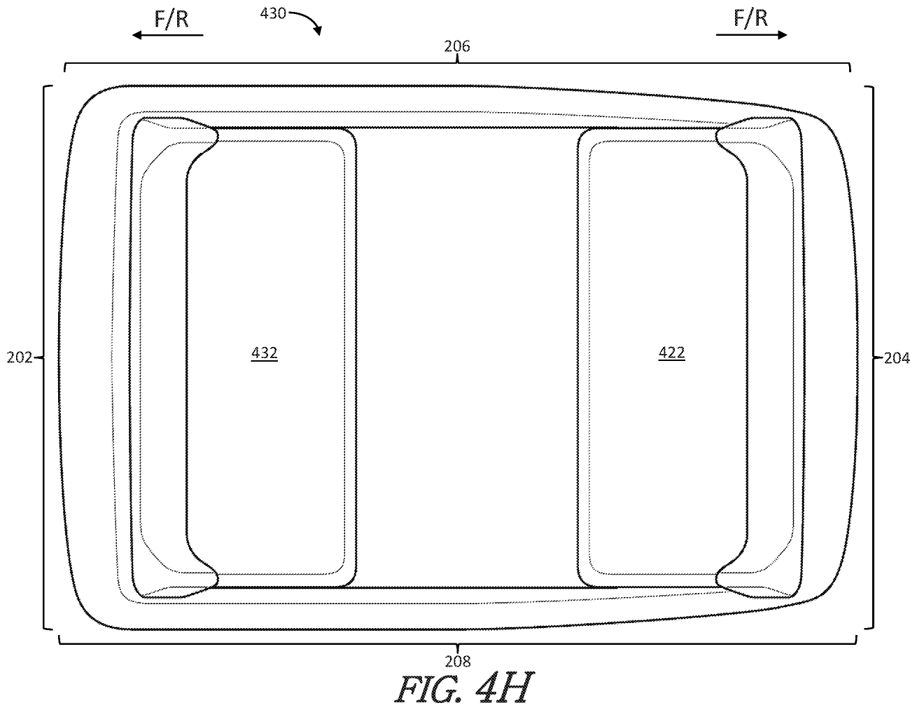

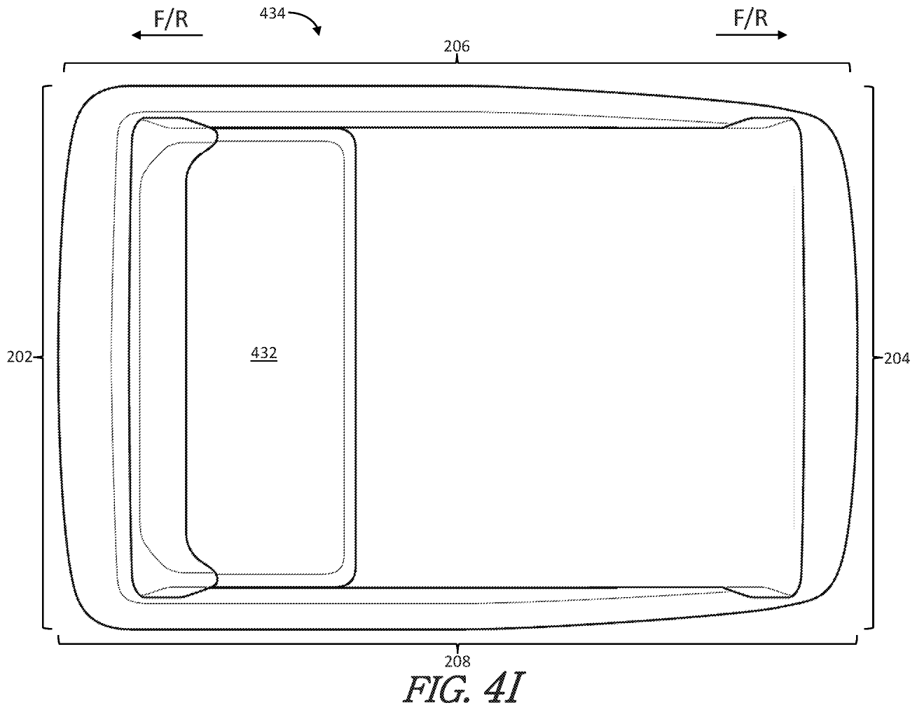

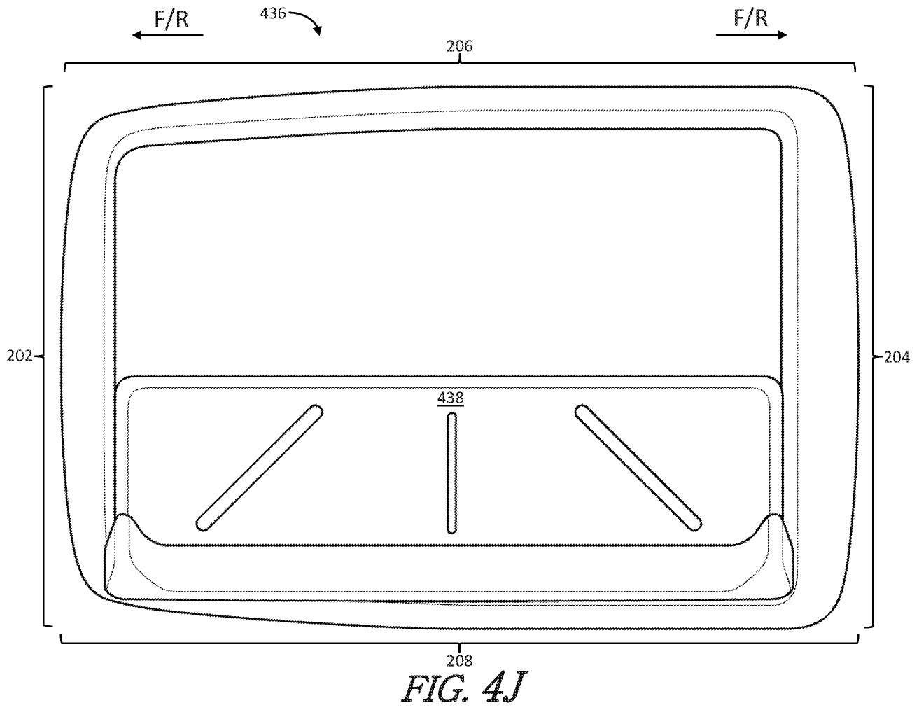

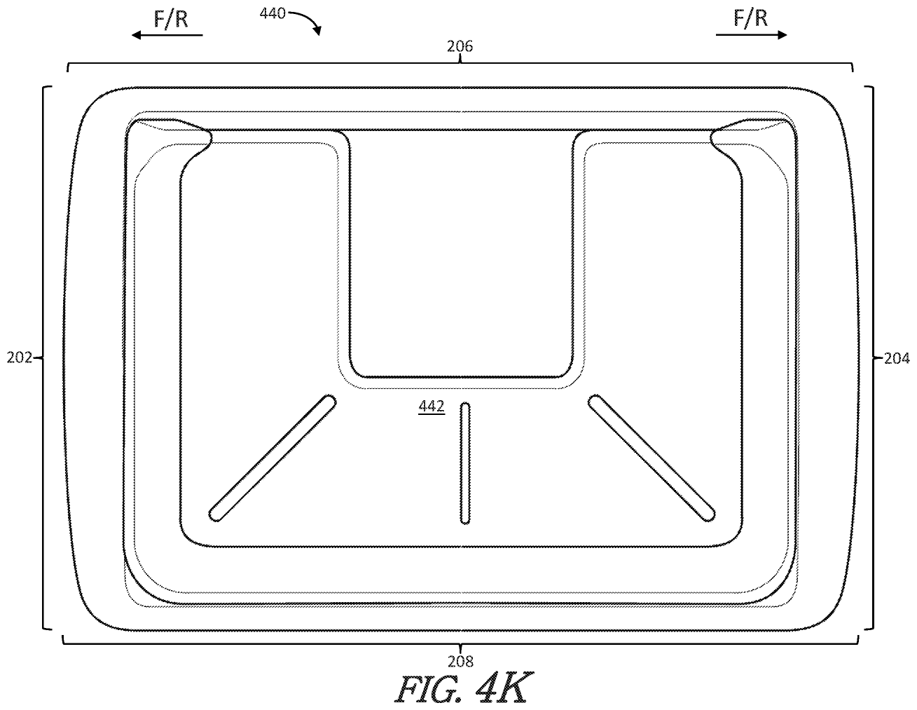

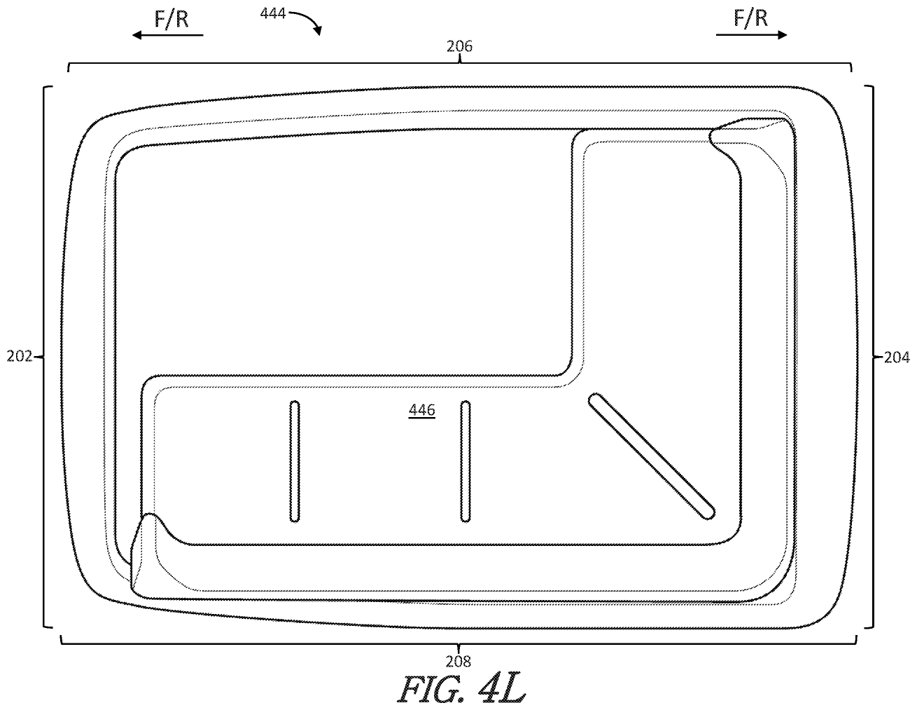

In some embodiments, interior 200 can include one or more modular interior units comprising one or more reclining seats for accommodating one or more passengers. Additionally or alternatively, interior 200 can include one or more modular interior units comprising one or more bench seats for accommodating one or more passengers. In some embodiments, interior 200 can include one or more modular interior units comprising one or more reclining seats and one or more bench seats for accommodating one or more passengers. For example, FIGS. 4A-L depict example layouts of an interior arrangement of an autonomous vehicle according to example embodiments of the present disclosure.

Referring to FIG. 4A, in some embodiments, interior 200 can be configured in accordance with layout 400. Layout 400 can include one or more modular interior units comprising reclining seat 402 and reclining seat 406, for example, such unit(s) can be coupled to one or more mechanical interfaces of one or more of portions 212, 214, 216, 218, 220, and/or 222. Layout 400 can also include one or more modular interior units comprising reclining seat 404 and reclining seat 408, for example, such unit(s) can be coupled to one or more mechanical interfaces (e.g., interfaces 302A, 302B, 302C, and/or 302D) of one or more of portions 236, 238, 240, 242, 244, and/or 246. As illustrated, seats 402 and 404 can be located adjacent to side 206. Similarly, seats 406 and 408 can be located adjacent to side 208. The unit(s) comprising seats 402 and 406 can be configured such that one or more passengers accommodated by seats 402 and/or 406 face side 204. Similarly, the unit(s) comprising seats 404 and 408 can be configured such that one or more passengers accommodated by seats 404 and/or 408 face side 202.

Referring to FIG. 4B, in some embodiments, interior 200 can be configured in accordance with layout 410. Layout 410 can include one or more modular interior units comprising reclining seat 402 and reclining seat 406, for example, such unit(s) can be coupled to one or more mechanical interfaces of one or more of portions 212, 214, 216, 218, 220, and/or 222. Layout 410 can also include one or more modular interior units comprising reclining seat 404 and bench seat 412, for example, such unit(s) can be coupled to one or more mechanical interfaces of one or more of portions 236, 238, 240, 242, 244, and/or 246. As illustrated, seats 402 and 404 can be located adjacent to side 206. Similarly, seats 406 and 412 can be located adjacent to side 208. The unit(s) comprising seats 402 and 406 can be configured such that one or more passengers accommodated by seats 402 and/or 406 face side 204. Similarly, the unit(s) comprising seats 404 and 412 can be configured such that one or more passengers accommodated by seats 404 and/or 412 face side 202.

Referring to FIG. 4C, in some embodiments, interior 200 can be configured in accordance with layout 414. Layout 414 can include one or more modular interior units comprising reclining seat 402 and bench seat 416, for example, such unit(s) can be coupled to one or more mechanical interfaces of one or more of portions 212, 214, 216, 218, 220, and/or 222. Layout 414 can also include one or more modular interior units comprising reclining seat 408 and bench seat 418, for example, such unit(s) can be coupled to one or more mechanical interfaces of one or more of portions 236, 238, 240, 242, 244, and/or 246. As illustrated, seats 402 and 418 can be located adjacent to side 206. Similarly, seats 416 and 408 can be located adjacent to side 208. The unit(s) comprising seats 402 and 416 can be configured such that one or more passengers accommodated by seats 402 and/or 416 face side 204. Similarly, the unit(s) comprising seats 408 and 418 can be configured such that one or more passengers accommodated by seats 408 and/or 418 face side 202. It will be appreciated that a passenger in seat 402 can face in the direction of a passenger in seat 408 but may not be located directly across interior 200 from the passenger in seat 408, which can, for example, provide additional space for one or more of seats 402 and/or 408 to recline within interior 200, and/or the like.

Referring to FIG. 4D, in some embodiments, interior 200 can be configured in accordance with layout 420. Layout 420 can include one or more modular interior units comprising reclining seat 402 and reclining seat 406, for example, such unit(s) can be coupled to one or more mechanical interfaces of one or more of portions 212, 214, 216, 218, 220, and/or 222. Layout 420 can also include one or more modular interior units comprising bench seat 422, for example, such unit(s) can be coupled to one or more mechanical interfaces of one or more of portions 236, 238, 240, 242, 244, and/or 246. As illustrated, seat 402 can be located adjacent to side 206. Similarly, seat 406 can be located adjacent to side 208. The unit(s) comprising seats 402 and 406 can be configured such that one or more passengers accommodated by seats 402 and/or 406 face side 204. Similarly, the unit(s) comprising seat 422 can be configured such that one or more passengers accommodated by seat 422 face side 202.

Referring to FIG. 4E, in some embodiments, interior 200 can be configured in accordance with layout 424. Layout 424 can include one or more modular interior units comprising reclining seat 402 and reclining seat 406, for example, such unit(s) can be coupled to one or more mechanical interfaces of one or more of portions 212, 214, 216, 218, 220, and/or 222. As illustrated, seat 402 can be located adjacent to side 206. Similarly, seat 406 can be located adjacent to side 208. The unit(s) comprising seats 402 and 406 can be configured such that one or more passengers accommodated by seats 402 and/or 406 face side 204.

Referring to FIG. 4F, in some embodiments, interior 200 can be configured in accordance with layout 426. Layout 426 can include one or more modular interior units comprising reclining seat 402 and bench seat 416, for example, such unit(s) can be coupled to one or more mechanical interfaces of one or more of portions 212, 214, 216, 218, 220, and/or 222. Layout 426 can also include one or more modular interior units comprising bench seat 422, for example, such unit(s) can be coupled to one or more mechanical interfaces of one or more of portions 236, 238, 240, 242, 244, and/or 246. As illustrated, seat 402 can be located adjacent to side 206. Similarly, seat 416 can be located adjacent to side 208. The unit(s) comprising seats 402 and 416 can be configured such that one or more passengers accommodated by seats 402 and/or 416 face side 204. Similarly, the unit(s) comprising seat 422 can be configured such that one or more passengers accommodated by seat 422 face side 202.

Referring to FIG. 4G, in some embodiments, interior 200 can be configured in accordance with layout 428. Layout 428 can include one or more modular interior units comprising reclining seat 402 and bench seat 416, for example, such unit(s) can be coupled to one or more mechanical interfaces of one or more of portions 212, 214, 216, 218, 220, and/or 222. As illustrated, seat 402 can be located adjacent to side 206. Similarly, seat 416 can be located adjacent to side 208. The unit(s) comprising seats 402 and 416 can be configured such that one or more passengers accommodated by seats 402 and/or 416 face side 204.

Referring to FIG. 4H, in some embodiments, interior 200 can be configured in accordance with layout 430. Layout 430 can include one or more modular interior units comprising bench seat 432, for example, such unit(s) can be coupled to one or more mechanical interfaces of one or more of portions 212, 214, 216, 218, 220, and/or 222. Layout 430 can also include one or more modular interior units comprising bench seat 422, for example, such unit(s) can be coupled to one or more mechanical interfaces of one or more of portions 236, 238, 240, 242, 244, and/or 246. The unit(s) comprising seat 432 can be configured such that one or more passengers accommodated by seat 432 face side 204. Similarly, the unit(s) comprising seat 422 can be configured such that one or more passengers accommodated by seat 422 face side 202.

Referring to FIG. 4I, in some embodiments, interior 200 can be configured in accordance with layout 434. Layout 434 can include one or more modular interior units comprising bench seat 432, for example, such unit(s) can be coupled to one or more mechanical interfaces of one or more of portions 212, 214, 216, 218, 220, and/or 222. The unit(s) comprising seat 432 can be configured such that one or more passengers accommodated by seat 432 face side 204.

Referring to FIG. 4J, in some embodiments, interior 200 can be configured in accordance with layout 436. Layout 436 can include one or more modular interior units comprising bench seat 438, for example, such unit(s) can be coupled to one or more mechanical interfaces of one or more of portions 220, 222, 224, 226, 228, 230, 232, 234, 236, and/or 238. The unit(s) comprising seat 438 can be configured such that one or more passengers accommodated by seat 438 face side 206.

Referring to FIG. 4K, in some embodiments, interior 200 can be configured in accordance with layout 440. Layout 440 can include one or more modular interior units comprising bench seat 442, for example, such unit(s) can be coupled to one or more mechanical interfaces of one or more of portions 212, 214, 216, 218, 220, 222, 224, 226, 228, 230, 232, 234, 236, 238, 240, 242, 244, and/or 246. The unit(s) comprising seat 442 can be configured such that at least one passenger accommodated by seat 442 faces side 202, at least one passenger accommodated by seat 442 faces side 204, and at least one passenger accommodated by seat 442 faces side 206.

Referring to FIG. 4L, in some embodiments, interior 200 can be configured in accordance with layout 444. Layout 444 can include one or more modular interior units comprising bench seat 446, for example, such unit(s) can be coupled to one or more mechanical interfaces of one or more of portions 220, 222, 224, 226, 228, 230, 232, 234, 236, 238, 240, 242, 244, and/or 246. The unit(s) comprising seat 446 can be configured such that at least one passenger accommodated by seat 446 faces side 202 and at least one passenger accommodated by seat 446 faces side 206.

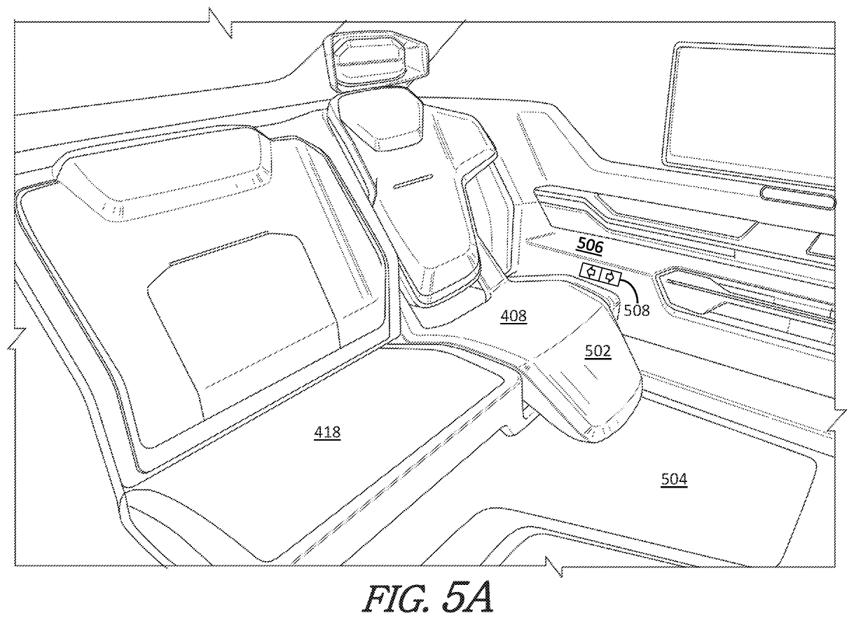

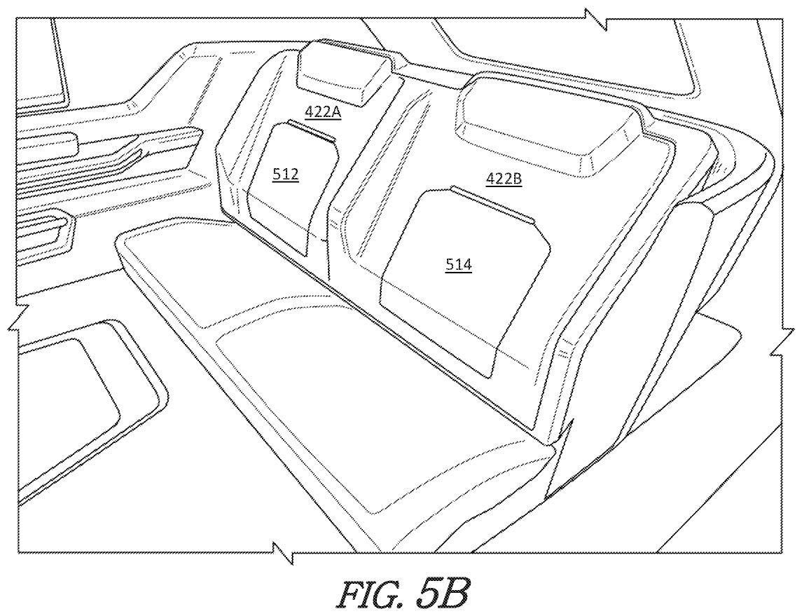

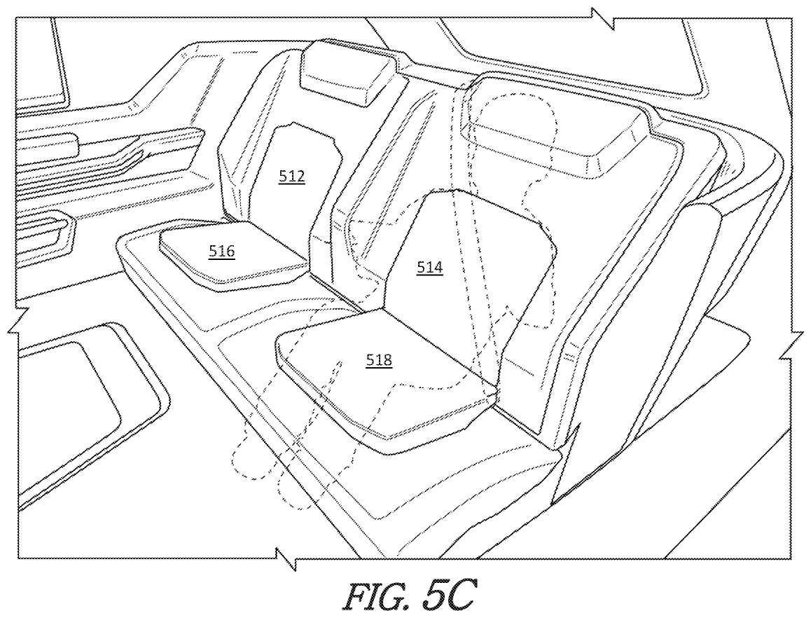

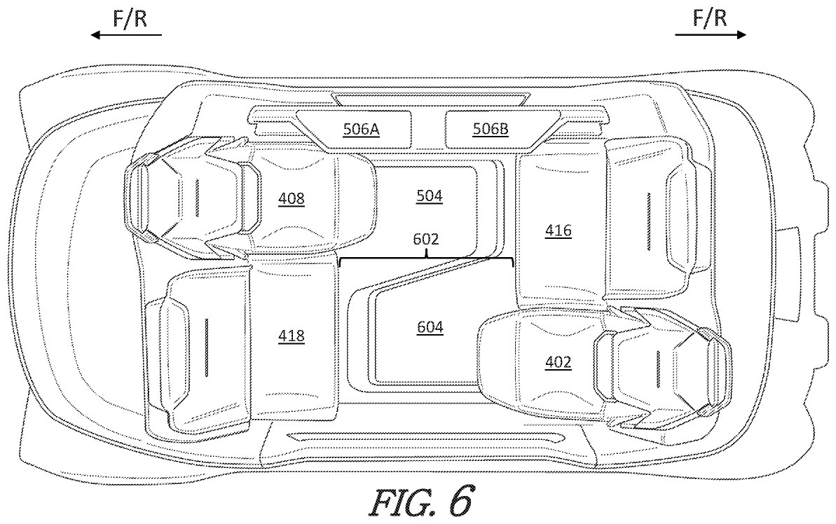

FIGS. 5A-C depict example designs of aspects of an interior arrangement of an autonomous vehicle according to example embodiments of the present disclosure, and FIG. 6 depicts an example design of an interior arrangement of an autonomous vehicle according to example embodiments of the present disclosure.

In some embodiments, one or more reclining seats included in one or more modular interior units of interior 200 can include one or more leg rests. For example, referring to FIG. 5A, seat 408 can include leg rest 502.

In some embodiments, interior 200 can include one or more floor panels. For example, referring to FIG. 6, interior 200 can include one or more floor panels 602. In some of such embodiments, floor panel(s) 602 can define one or more coves into which one or more leg rests of interior 200 can be configured to extend. For example, floor panel(s) 602 can define cove 504, into which leg rest 502 can be configured to extend. Similarly, floor panel(s) 602 can define cove 604, into which a leg rest of seat 402 can be configured to extend.

In some embodiments, interior 200 can include one or more modular interior units comprising one or more consoles. For example, interior 200 can include one or more modular interior units comprising one or more consoles 506, for example, such unit(s) can be coupled to one or more mechanical interfaces of one or more of portions 222, 224, 226, 228, 230, 232, 234, and/or 236. Console(s) 506 can include portion 506A comprising a console for a passenger seated in seat 408, portion 506B comprising a console for a passenger seated in seat 416, and/or the like.

In some embodiments, panel(s) 602 can be secured to interior 200, at least in part, by one or more modular interior units of interior 200, for example, via one or more mechanical interfaces of the interior portions to which the unit(s) are coupled (e.g., one or more components of the interface(s) can pass through one or more openings in panel(s) 602, and/or the like). For example, panel(s) 602 can be secured to interior 200 by one or more of the units including seats 402, 408, 416, and/or 418, and/or console(s) 506.

In some embodiments, panel(s) 602 can be configured to cover one or more mechanical interfaces of interior 200 (e.g., one or more interfaces not being utilized to couple a modular interior unit, and/or the like). For example, panel(s) 602 can be configured to cover one or more mechanical interfaces of portions 224, 226, 228, 230, 232, and/or 234 (e.g., one or more modular interior units comprising console(s) 506 can be coupled to one or more mechanical interfaces of such portion(s) proximate to side 208, panel(s) 602 can be configured to cover one or more unutilized mechanical interfaces of such portion(s) distal to side 208, and/or the like).

In some embodiments, one or more modular interior units of interior 200 can include a bench seat comprising one or more stowable child seats for accommodating one or more passengers (e.g., children, and/or the like). For example, referring to FIG. 5B, seat 422 can include portion 422A comprising stowable child seat 512, and seat 422 can include portion 422B comprising stowable child seat 514. In some of such embodiments, one or more portions of such stowable child seat(s) can fold into the bench seat (e.g., for storage, and/or the like). For example, referring to FIG. 5C, portion 516 of seat 512 can fold into portion 422A, portion 518 of seat 514 can fold into portion 422B, and/or the like.

Returning to FIG. 5A, console(s) 506 can include one or more controls 508 for one or more functions of autonomous vehicle 10. For example, seat 408 can include one or more electronically adjustable positions, and control(s) 508 can be configured to adjust such position(s), and/or the like. The unit(s) comprising seat 408 can be coupled to one or more of interfaces 302A, 302B, 302C, and/or 302D, and such unit(s) can include one or more electronic interfaces configured to electronically interface with interface 304 and can interface with autonomous vehicle 10 via interface 304. Similarly, the unit(s) comprising control(s) 508 can be coupled to one or more of interfaces 306A, 306B, 306C, and/or 306D, and such unit(s) can include one or more electronic interfaces configured to electronically interface with interface 308 and can interface with autonomous vehicle 10 via interface 308. In some embodiments, interfaces 304 and 308 can share a common configuration, be interchangeable, and/or the like. Accordingly, a passenger of autonomous vehicle 10 (e.g., seated in seat 408, and/or the like) can utilize control(s) 508 to adjust the position(s) of seat 408 via interfaces 304 and 308, and/or the like.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. An autonomous vehicle comprising:
an interior comprising a plurality of different portions, each portion of the plurality of different portions comprising one or more mechanical interfaces associated therewith; and
at least one modular interior unit configured to accommodate one or more passengers, the at least one modular unit being coupled to one or more mechanical interfaces of at least one portion of the plurality of different portions of the interior.

2. The autonomous vehicle of claim 1, wherein the at least one modular interior unit comprises a bench seat for accommodating the one or more passengers.

3. The autonomous vehicle of claim 2, wherein the bench seat comprises one or more stowable child seats for accommodating the one or more passengers.

4. The autonomous vehicle of claim 3, wherein for each seat, of the one or more stowable child seats, at least a portion of the seat folds into the bench seat.

5. The autonomous vehicle of claim 2, wherein:
the interior comprises at least four sides;
the plurality of different portions comprises one or more portions at least partially bordering a first side of the at least four sides; and
the at least one modular interior unit is:
coupled to one or more mechanical interfaces of the one or more portions at least partially bordering the first side, and
configured to accommodate the one or more passengers such that the one or more passengers face a second side of the at least four sides, the second side being opposite the first side.

6. The autonomous vehicle of claim 2, wherein:
the interior comprises at least four sides;
the plurality of different portions comprises:
one or more portions at least partially bordering a first side of the at least four sides, and
one or more portions at least partially bordering a second side of the at least four sides; and
the at least one modular interior unit is:
coupled to one or more mechanical interfaces of the one or more portions at least partially bordering the first side,
coupled to one or more mechanical interfaces of the one or more portions at least partially bordering the second side,
configured to accommodate at least one passenger of the one or more passengers such that the at least one passenger faces a third side of the at least four sides, the third side being opposite the first side, and
configured to accommodate at least one additional passenger of the one or more passengers such that the at least one additional passenger faces a fourth side of the at least four sides, the fourth side being opposite the second side.

7. The autonomous vehicle of claim 2, wherein:
the interior comprises at least four sides;
the plurality of different portions comprises:
one or more portions at least partially bordering a first side of the at least four sides,
one or more portions at least partially bordering a second side of the at least four sides, and
one or more portions at least partially bordering a third side of the at least four sides; and
the at least one modular interior unit is:
coupled to one or more mechanical interfaces of the one or more portions at least partially bordering the first side,
coupled to one or more mechanical interfaces of the one or more portions at least partially bordering the second side,
coupled to one or more mechanical interfaces of the one or more portions at least partially bordering the third side,
configured to accommodate at least one passenger of the one or more passengers such that the at least one passenger faces the third side, the third side being opposite the first side,
configured to accommodate at least one additional passenger of the one or more passengers such that the at least one additional passenger faces a fourth side of the at least four sides, the fourth side being opposite the second side, and
configured to accommodate at least one further passenger of the one or more passengers such that the at least one further passenger faces the first side of the at least four sides.

8. The autonomous vehicle of claim 1, wherein:
the at least one modular interior unit comprises one or more units including a reclining seat;
the interior comprises at least four sides;
the plurality of different portions comprises one or more portions at least partially bordering a first side of the at least four sides; and
the one or more units including the reclining seat are:
coupled to one or more mechanical interfaces of the one or more portions at least partially bordering the first side such that the reclining seat is at least partially adjacent to a second side of the at least four sides, and
configured to accommodate at least one passenger of the one or more passengers such that the at least one passenger faces one of either a front of the autonomous vehicle or a rear of the autonomous vehicle.

9. The autonomous vehicle of claim 8, wherein:
the at least one modular interior unit comprises one or more units including an additional reclining seat;
the plurality of different portions comprises one or more portions at least partially bordering a third side of the at least four sides, the third side being opposite the first side; and
the one or more units including the additional reclining seat are:
coupled to one or more mechanical interfaces of the one or more portions at least partially bordering the third side such that the additional reclining seat is at least partially adjacent to a fourth side of the at least four sides, the fourth side being opposite the second side, and
configured to accommodate at least one additional passenger of the one or more passengers such that the at least one additional passenger faces the first side.

10. The autonomous vehicle of claim 8, wherein the one or more units including the reclining seat comprise a bench seat configured to accommodate at least one additional passenger of the one or more passengers such that the at least one additional passenger faces the one of either the front of the autonomous vehicle or the rear of the autonomous vehicle.

11. The autonomous vehicle of claim 8, wherein the reclining seat comprises a leg rest configured to extend into a cove defined, at least in part, by one or more floor panels of the interior.

12. The autonomous vehicle of claim 11, wherein:
the plurality of different portions comprises one or more portions at least partially bordering a second side of the at least four sides; and
at least one floor panel of the one or more floor panels covers one or more mechanical interfaces of the one or more portions at least partially bordering the second side.

13. The autonomous vehicle of claim 11, wherein at least one unit of the one or more units including the reclining seat secures, at least in part, at least one floor panel of the one or more floor panels via at least one mechanical interface of the one or more mechanical interfaces of the one or more portions at least partially bordering the first side.

14. The autonomous vehicle of claim 1, wherein the at least one modular interior unit is electronically interfaced with the autonomous vehicle via one or more electronic interfaces of the at least one portion of the plurality of different portions of the interior.

15. The autonomous vehicle of claim 14, wherein:
the at least one modular interior unit includes a first unit and a second unit;
the first unit is electronically interfaced with the autonomous vehicle via a first electronic interface of the one or more electronic interfaces;
the second unit is electronically interfaced with the autonomous vehicle via a second electronic interface of the one or more electronic interfaces; and
the second unit comprises one or more controls configured to operate one or more functions of the first unit via the first electronic interface and the second electronic interface.

16. The autonomous vehicle of claim 15, wherein:
the first unit includes a reclining seat;
the second unit includes a console comprising the one or more controls; and
the one or more functions adjust one or more positions of the reclining seat.

17. The autonomous vehicle of claim 1, wherein:
each portion of the plurality of different portions is defined by at least two dimensions; and
a first dimension of the at least two dimensions is an even multiple of a second dimension of the at least two dimensions.

18. The autonomous vehicle of claim 1, wherein the one or more mechanical interfaces of the at least one portion comprise one or more components configured to interface with a device comprising specialized tooling for decoupling the at least one modular interior unit from the one or more mechanical interfaces of the at least one portion.

19. An autonomous-vehicle interior comprising:
a first side, the first side comprising one or more doors for one or more passengers to enter and exit the autonomous vehicle;
a second side, the second side comprising one or more mechanical interfaces associated therewith;
a third side, the third side comprising one or more mechanical interfaces associated therewith, the third side being opposite the second side;
a fourth side, the fourth side comprising one or more mechanical interfaces associated therewith, the fourth side being opposite the first side;
one or more modular units coupled to the one or more mechanical interfaces of the second side and including a first reclining seat, the first reclining seat being at least partially adjacent to the first side and configured to accommodate a first passenger of the one or more passengers such that the first passenger faces one of either a front of the autonomous vehicle or a rear of the autonomous vehicle;
one or more modular units coupled to the one or more mechanical interfaces of the third side and including a second reclining seat, the second reclining seat being at least partially adjacent to the fourth side and configured to accommodate a second passenger of the one or more passengers such that the second passenger faces the second side; and
one or more modular units coupled to the one or more mechanical interfaces of the fourth side and including one or more controls for adjusting one or more of the first reclining seat or the second reclining seat.

20. An autonomous-vehicle interior comprising:
a first side, the first side comprising one or more doors for one or more passengers to enter and exit the autonomous vehicle;
a second side, the second side comprising a reclining seat and a bench seat; and
a third side, the third side comprising a reclining seat and a bench seat, wherein:
the reclining seat of the second side is at least partially adjacent to the first side and configured to accommodate a first passenger of the one or more passengers such that the first passenger faces one of either a front of the autonomous vehicle or a rear of the autonomous vehicle,
the bench seat of the second side is at least partially adjacent to a fourth side of the autonomous vehicle and configured to accommodate a second passenger of the one or more passengers such that the second passenger faces the one of either the front of the autonomous vehicle or the rear of the autonomous vehicle,
the fourth side is opposite the first side,
the reclining seat of the third side is at least partially adjacent to the fourth side and configured to accommodate a third passenger of the one or more passengers such that the third passenger faces the second side, and
the bench seat of the third side is at least partially adjacent to the first side and configured to accommodate a fourth passenger of the one or more passengers such that the fourth passenger faces the second side.
